(19) United States
(12) Patent Application Publication
(10) Pub. No.: US 2022/0039400 A1
(43) Pub. Date: Feb. 10, 2022

(54) Pressure-Controlled Dough-Rounding Device

(71) Applicant: König Maschinen Gesellschaft m.b.H., Graz (AT)

(72) Inventors: Eduard Rauch, St. Margarethen (AT); Hannes Stelzer, Lannach (AT)

(21) Appl. No.: 17/275,246

(22) PCT Filed: Sep. 11, 2019
(86) PCT No.: PCT/AT2019/060296

§ 371 Date: Mar. 11, 2021

(30) Foreign Application Priority Data
Sep. 11, 2018 (AT) A50773/2018

(51) Int. Cl. A21C 7/04; A21C 9/08

(52) U.S. Cl. CPC A21C 7/04; A21C 9/08

(57) ABSTRACT

A working system for working pieces of dough, including: at least one working cup, each having an opening, a receiving space for receiving pieces of dough and a working insert, the working insert delimiting the receiving space on the side of the receiving space remote from the opening; an abutment, which is arranged opposite the opening of the working cup; a height adjustment device, which is designed to reversibly, in particular mechanically, electromechanically, pneumatically or hydraulically, move the at least one working cup from a starting position remote from the abutment to a working position near the abutment; and a drive unit, which is designed to set the at least one working cup into oscillating motion. Each of the at least one working cups has a pressure cylinder having a pressure piston that can move in the pressure cylinder. A pressure control unit is pressure-transmittingly connected to the pressure cylinder.

### TECHNICAL FIELD

The present teaching relates to a working system for working pieces of dough according to the generic terms of this disclosure as well as a dough-processing installation.

### BACKGROUND

Known from the prior art are a number of working systems that are used for the production of the most diverse types of baked goods. Common to known working systems is that they include working cups into which pieces of dough, contiguous with an abutment, are received for working. Known working cups of this kind are primarily equipped with a working inset, whose surface is in targeted contact with the pre-portioned piece of dough. The working insert of the working cup applies an oscillating motion to the working of the pieces of dough.

The range of products and the quality demands of the different types of baked goods are constantly increasing. To improve standards and/or to satisfy trends such as organic baked goods or baked goods that are produced without the addition of certain food additives and the like, there is an increasing tendency to avoid auxiliary baking agents, which means that such doughs are subjected to “slow baking” and produced from organic raw materials. This requires adaptation of production facilities in accordance with these demands or to provide equipment with maximum flexibility. These doughs are associated with essentially higher demands concerning the entire production process, because they are essentially distinguished from doughs containing additives to achieve “mechanical speed.” Moreover, during the working process, doughs change their characteristics and/or their behavior more quickly. Therefore, it is essential for the dough-working process to be conducted with an emphasis on kettle fermentation, called “slow baking” by specialists, and/or to treat doughs with a high quantity of fermentation bubbles as closely as possible to hand-processing. Because this type of dough processing systems, however, also process “green” doughs, that is, doughs with few fermentation bubbles, the requirements connected with such processes must also be met. With hand-working procedures, the dough is first pressed against the base, and then the kneading begins; in the course of spherical configuration the hand reduces pressure and releases space or height for the desired configuration of the ball. Thus, for the processing of diverse doughs, a range of working pressures or guidelines for pressure characteristic curves are necessary in order to adapt hand working processes to an automated process.

With familiar devices in the prior art, springs are used to produce the required pressures. It is also common to perform the withdrawal movement mechanically, for example to effect it by means of curve discs or electromechanically. These familiar methods, however, are not sufficient for slow-working doughs and the associated quality requirements. Basically, for such processes, systems with springs comprise an inverse guideline, during the “impacting” of the piece of dough, and meanwhile contact between the working base and the piece of dough continues, exerting too little and/or too great a pressure during the formation of a ball from the piece of dough, which does not meet the requirements of slow doughs. Mechanical or electromechanical systems operate according to a model, which must be or ought to be controlled permanently according to the dough varieties and the degree of ripeness of these doughs, a process which can be demanding.

In addition, at the start of the working process, stronger pressure is required in pressing pieces of dough against the abutment and into the working containers, so that the pieces of dough are fixed in the short term in the working containers. With the start of the working process begins the formation of the ball shape; the flat piece of dough increases in height until it forms a complete ball. This means that the working cup “yields” the required height. Firm or green doughs demand greater pressure and a steep characteristic curve, and/or on the other hand gas-containing doughs require lower to no pressure and a very flat characteristic curve. Core tension is directly connected with the curve.

Higher initial pressure produces this firm core tension, while lower pressure leads to light core tension. The desired core tension sets the standard for the following additional processing or shaping. If flat pastry is desired, core tension is kept lower than if the baked goods are intended to be high and ball-like, that is, to demonstrate class and quality. In this case, firm core tension is essential.

### SUMMARY

It is therefore one object of the present teaching to provide assistance in this respect and to make a working system available that makes it possible to apply different working pressures and working pressure characteristic curves during the work process for doughs of various types, and in this way to emulate hand processing as far as possible.

The present teaching fulfills this object with a working system for working pieces of dough. A working system of this type includes:

at least one working cup, which in each case comprises an opening, a receiving space for introducing pieces of dough and a working inset, wherein the working inset delimits the receiving space on its side opposite the opening,

an abutment arranged opposite the opening of the working cup—a height adjustment device, which is configured to convert the at least one working cup from a starting position, far from the abutment, to a working position close to the abutment, reversibly, particularly mechanically, electromechanically, pneumatically or hydraulically, and

a drive unit, configured to set the at least one working cup into oscillating motion.

According to the present teaching, the at least one working cup in each case comprises a pressure cylinder with a pressure piston that can move inside the pressure cylinder, and a pressure control unit is provided which is pressure-transmittingly connected to the pressure cylinder. The pressure control unit is configured to apply a variable pressure and/or volume to the pressure cylinder. The pressure cylinder, in turn, is pressure-transmittingly connected to the working inset in such a way that, upon varying the pressure in the pressure cylinder and/or of the pressure characteristic curve of the pressure control unit, the force acting on the working inset can be changed.

The pressure system possesses, for instance, a storage unit with variable volume. By changing the pressure, the pressure during kneading can be adjusted, while by changing the volume in the pressure storage unit the angle of the curve is controlled. “Green” doughs require a steep characteristic curve; long-cooked doughs need a flat curve.

This configuration of the present teaching serves to assure that the working pressure in kneading corresponds to handwork and the characteristic curve for doughs corresponding to the weight-per-piece and defined size, which is optimally adjustable, depending on the amount of fermentation bubbles and thus the density of the piece of dough, without for example needing to replace the working cup or working insets of the working system. The term “work” hereinafter is understood to mean rounding, as well as the lengthy working of pieces of dough.

As a result of the pressure control unit, the pressure applied to the pieces of dough in the working process via the work insets is variable or controllable, so that the dough consistency changes arising during processing or working of the pieces of dough can be taken into account directly by changes in the pressure acting on the working insets as well as the pressure characteristic curve.

Particularly good pressure adjustment to different varieties of dough or dough consistencies can be achieved if the pressure control unit is configured to apply to the pressure cylinder a predetermined, constant pressure or a pressure corresponding at least to a predetermined, particularly linear or variable pressure characteristic curve, so that in each case the pressure acting on the working inset and the pressure characteristic curve are adjustable.

Thus, it is possible, for example, for pieces of dough of a certain variety of dough to generate\optimal working pressure by means, for instance, of a pump and to transmit it via the working inset onto the respective piece of dough. If pieces of dough of a different variety of dough are introduced into the working system for working, the working pressure can be accordingly lowered or raised without the working cup or working inset needing to be replaced.

With a particularly simply configured variant of the present teaching, with which a pressure that can vary during the working process, corresponding to a predetermined pressure characteristic curve, can be exerted on the working inset, it can be provided that the pressure control unit includes a first pressure-generating unit and a second pressure-generating unit, wherein the first pressure-generating unit and the second pressure-generating unit each are pressure-transmittingly connected to a pressure transmission unit, and are configured in such a way that in the pressure transmission unit a pressure corresponding at least to a given, especially linear or variable pressure characteristic curve can be adjusted and wherein the pressure transmission unit is transmittingly connected to the pressure cylinder.

The term “pressure characteristic curve” in this context is considered to mean the pressure-volume-flow characteristic curve. This means that the pressure exerted by the pressure control unit, which is transmitted via the pressure cylinder or the pressure piston to the working inset, increases if the volume conveyed per time unit increases.

A particularly efficient adjustment of various pressure characteristic curves can be obtained if the pressure transmission unit is configured as a piston storage unit, that is, as a hydro-pneumatic pressure storage unit,

wherein the piston storage unit comprises a hydraulic chamber that in particular is filled with hydraulic liquid, a pneumatic chamber that in particular is filled with gas, and a piston arranged between the hydraulic chamber and the pneumatic chamber,

wherein the first pressure-generating unit, particularly a compressor, is pressure-transmittingly connected to the pneumatic chamber,

wherein the second pressure-generating unit, particularly a hydraulic pump, is pressure-transmittingly connected to the hydraulic chamber,

wherein in the piston storage unit, by the application of pressure to the hydraulic chamber, pressure can be adjusted corresponding at least to a predetermined, especially linear or variable pressure characteristic curve, and

wherein the piston storage unit is configured to change the pressure and/or volume in the pressure cylinder.

By the use of a piston storage unit, high volume flows can be advantageously provided in the short term and great energy quantities can be stored at low intrinsic volume.

An especially rapid modification of the pressure characteristic curve, especially with the working system at high capacities or high flow rates, can be achieved if the pressure control unit includes at least one pump and a number of pressure storage units,

wherein the at least one pump is connected to the pressure cylinder via a pressure line,

wherein the pressure storage units can be switched into the pressure line by valves and in each case comprise a pre-set, especially linear or variable pressure characteristic curve, and

wherein the pressure-control unit is configured, particularly by opening and/or closing the valves, to apply pressure, corresponding to a particularly linear or variable pressure characteristic curve resulting from the pressure characteristic curves of the pressure storage unit, to the pressure cylinder of the at least one working cup,

In a technically and energy-technologically especially efficient embodiment, the pressure control system includes two pressure storage units and one reversible pumping system similar to an anti-blocking system (ABS) in automotive technology. Here the pressure and pressure characteristic curve can be achieved with only one pump and two blocking valves and the control reacts quickly enough to reach high pulses of up to 100/min, which require a minimum of energy.

For particularly efficient working of pieces of dough, it can be foreseen that the working inset is configured to transmit the pressure transmitted by the pressure piston to the working inset as a force acting orthogonally to the abutment.

To further optimize the working of pieces of dough, while simultaneously insuring that the entire surface of the pieces of dough is exposed to ideal working pressure, so that the surface becomes enlarged and the core tension of the pieces of dough is improved, it can be foreseen that the abutment comprises at least a working base, particularly in the form of one or more recesses, for fixing the pieces of dough on the abutment, wherein it is particularly foreseen that the working base in each case is made up of a number of concentric recessed grooves.

The working bases here are configured, for example, as one or more recesses in the surface of the abutment or the conveyor belt running on the abutment, which produce a targeted contact with the pre-portioned piece of dough, so that the piece of dough is worked efficiently. The working bases can be made, for example, of several grooves running parallel or concentrically.

To avoid damage to the piece of dough during working or harm to its surface or texture, it can be foreseen in all cases that, in working position, a working gap is left between the working cup and the abutment.

In order to equip working systems or working cups and working insets efficiently for various varieties of dough or dough qualities, it can be foreseen that

the working inset in each case comprises a smooth or structured surface and/or

the receiving space comprises an arched or semicircular cross-section and/or a round or oval projection surface.

A particularly effective adaptation of the working pressure or pressure characteristic curve to various varieties of dough can be achieved if the pressure characteristic curve can be adjusted by the pressure control unit corresponding to the dough rheology and/or the starting form of the pieces of dough. For this purpose it can be foreseen, for instance, that the rheological properties of the dough that is to be worked are ascertained during the process, for instance at predetermined time intervals and the pressure characteristic curve or the pressure impact of the working inset is adapted corresponding to the properties thus ascertained.

The present teaching also relates to a dough-processing system for processing strips of dough including an inventive working system, wherein the abutment comprises a reception side for receiving, in particular, pre-portioned, non-worked pieces of dough, and a delivery side for delivering worked pieces of dough. The dough-working system further includes at least one transport apparatus, configured for delivering unworked, in particular pre-portioned pieces of dough to the reception side of the abutment to the abutment, and/or to receive worked pieces of dough at the delivery side of the abutment from the abutment.

Owing to this design of a dough working system, it is possible, even in automated processing of dough strips, which are cut into portions or dough pieces by weight and/or volume, to adjust optimal, variable working pressures in the working of pieces of dough for various varieties or consistencies of dough.

Further advantages and configurations of the present teaching can be seen from the description and the annexed drawings.

### BRIEF DESCRIPTION OF THE DRAWINGS

FIG. 1 schematically shows two working cups and an abutment of an inventive working system.

FIG. 2a schematically shows the working of a piece of dough.

FIG. 2b schematically shows a flow diagram of a working process.

FIG. 2c schematically shows the start of the working process.

FIG. 2d schematically shows the end of the working process.

FIG. 2e shows a section of an abutment with a working base in cross-section.

FIG. 2f shows a section of an overhead view of an abutment with four working bases according to FIG. 2e.

FIG. 3a shows a section view of a working cup of an inventive working system in working position before the start of the working process.

FIG. 3b shows a first section view of the working cup in working position during the working process.

FIG. 3c shows a second section view of the working cup in working position during the working process.

FIG. 3d shows a section view of the working cup in the starting position with a worked piece of dough.

FIG. 4a shows a section view through a working cup without the application of pressure by the pressure control unit.

FIG. 4b shows a section view through the working cup with pressure applied.

FIG. 5 schematically shows a section view through two working cups with pressure applied by a combined hydraulic-pneumatic pressure control unit.

FIG. 6 shows a section view through a working cup with pressure applied by a hydraulic pressure control unit.

FIG. 7 shows a schematic depiction of a section view through an inventive working system.

FIG. 8 shows a schematic depiction of a section view through a working cup, with pressure applied by a pressure control unit with two buffer storage units.

### DETAILED DESCRIPTION

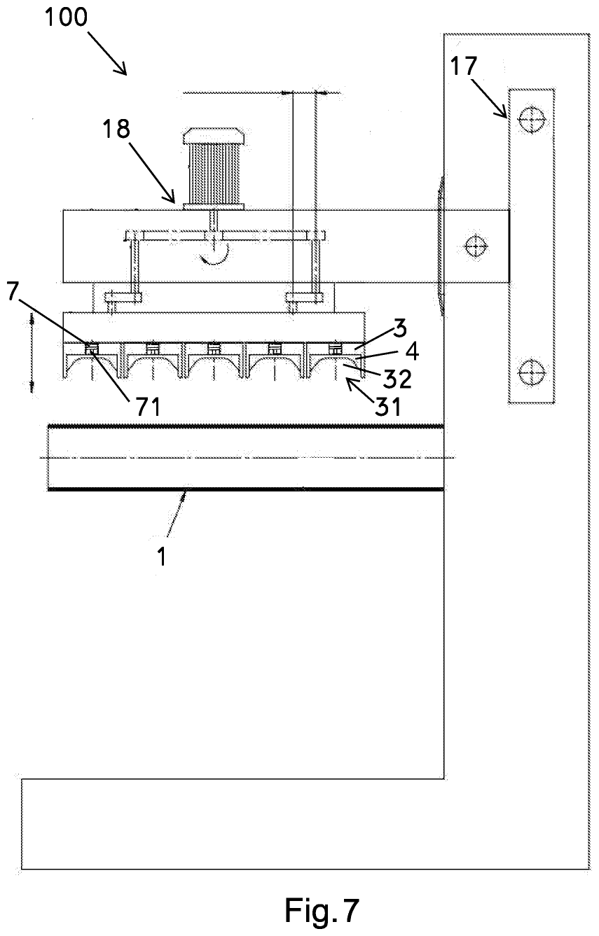

FIG. 7 is a schematic depiction of a section view through a first embodiment of an inventive working system 100 for working pieces of dough 5. The working system 100 in the illustrated embodiment includes several rows, each consisting of five working cups 3 alongside one another, which each comprise an opening 31 and a receiving space 32 for receiving pieces of dough 5. The receiving space 32 of each working cup 3 is delimited on the side of the receiving space remote from the opening 31 by a working insert 4.

The working system 100 further includes an abutment 1, which is arranged opposite the opening 31 of the working cup 3. In the illustrated embodiment, the abutment 1 takes the form of a conveyor belt on which the pieces of dough 5 are transported. The working system 100 also comprises, in the illustrated embodiment device, a height adjustment device 17, for example a mechanical or hydraulic moving device or an electrical lifting column, onto which the working cup 3 is moved from a starting position remote from the abutment 1 to a working position close to the abutment 1.

The working system 100 in the illustrated embodiment also comprises a height adjustment device 17, for example mechanical or hydraulic adjustment, or an electrical lifting column, which moves the working cup 3 from a starting position remote from the abutment 1 to a working position close to the abutment 1.

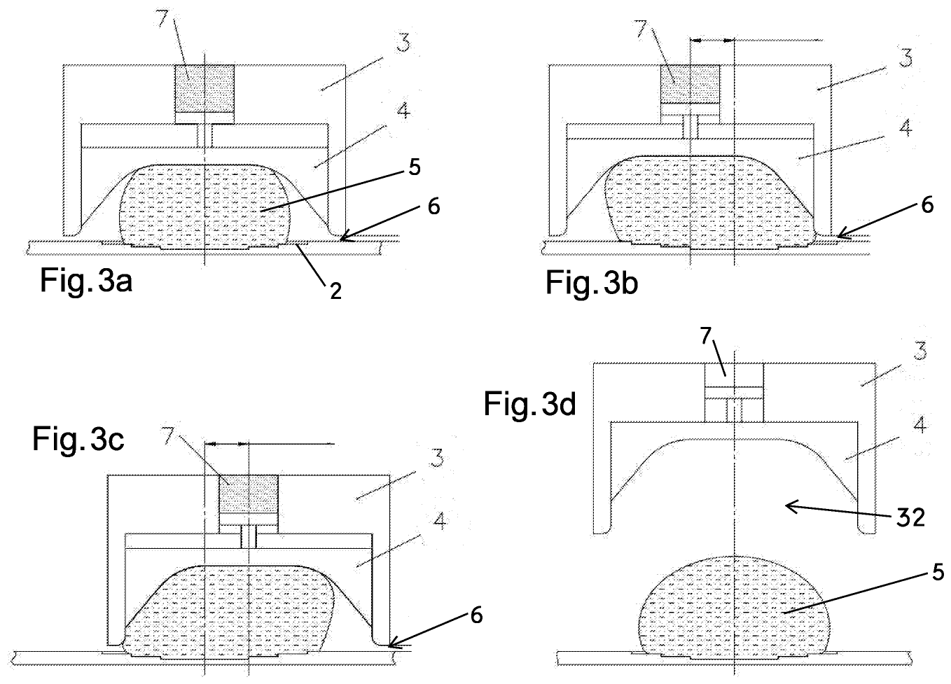

The pieces of dough 5 are transported on the abutment 1 into the area of the working cup 3 for working, and the height adjustment device 17 lowers the working cup from the starting position into the working position, so that the pieces of dough 5 are received through the opening 31 into the receiving space 32 of the working cup 3 (see FIGS. 3a, 3b, 3c). Thereby a working gap 6 is left free between the wall of the working cup 3 and the abutment 1 in order to avoid damaging the piece of dough 5 during working.

The cross-section of the receiving space 32, in the illustrated embodiment, has an arched shape, but alternatively it can also have, for instance, a semicircular shape. The projection surface of the receiving space 32, that is the surface that is delimited by the receiving space 32 in an overhead view of it, has a round shape in the illustrated embodiment but can optionally be oval, for example.

The working inset 4 in the illustrated embodiment has a smooth surface in each case, in order to assure that the dough does not stick to the working inset 4 and that the surface of the piece of dough 5 is not damaged. Alternatively, the working inset 4 could also comprise a structured surface, for example, for working firmer varieties of dough.

In addition, the working system 100 comprises a drive unit 18 which is designed to set the working cup 3 into oscillating motion. In the illustrated embodiment, the drive unit 18 includes a motor that is connected by operating elements such as, for example, belts to two working eccentric devices which give the impetus for the oscillating motion that the working cups 3 execute during the working of the pieces of dough 5.

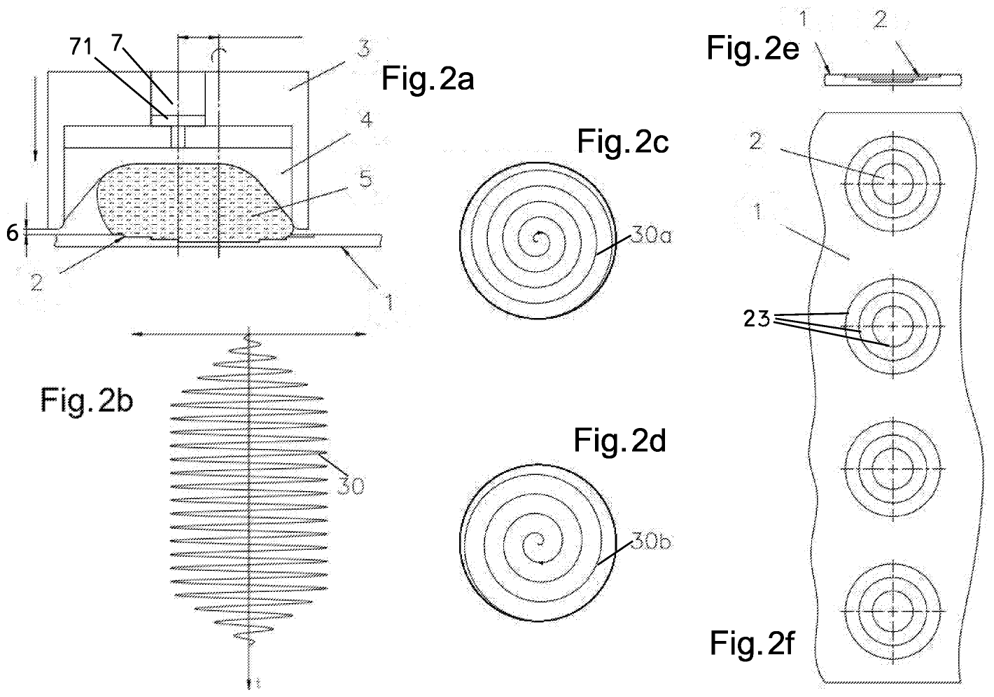

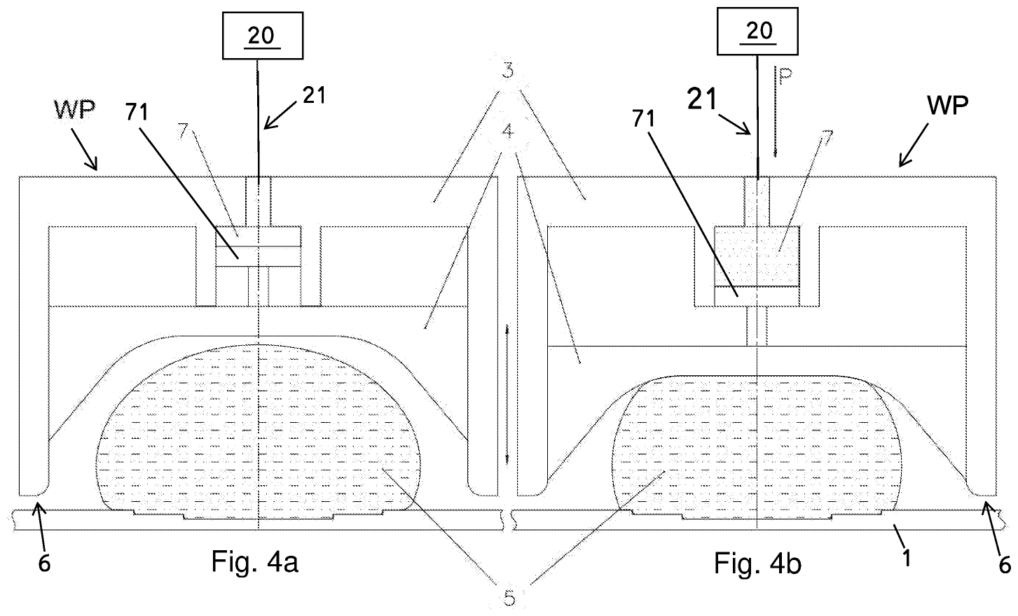

The working cups 3 of the working system 100 include one pressure cylinder 7 in each case, in which a pressure piston 71 can move and which, for example, are illustrated in detail in FIGS. 2a, 4a and 4b. In addition, the working system 100 includes a pressure control unit 20, which is pressure-transmittingly connected to the pressure cylinder 7 of each working cup 3, whereby a contiguous pressure in the pressure cylinder 7 is also transmitted to the pressure piston 71.

The pressure piston 71, in turn, is pressure-transmittingly connected to the working inset 4 of each pressure cup 3. Thereby, if the pressure control unit 20 applies, for example, an increasing pressure and/or volume to the pressure cylinder 7, the pressure piston 71 applies increasing pressure to the working inset 4, which pressure is transmitted to the piece of dough 5 by the working inset 4 as a force working orthogonally to the abutment 1. With decreasing pressure in the pressure cylinder 7, the pressure piston 71 lowers the pressure acting on the working inset 4, and the force working on the piece of dough 5 is likewise reduced.

As already described, in processing the widest range of products or varied dough consistencies and formulations, it is advantageous in the working process to also vary the force impact on the pieces of dough 5, because the working pressure decisively influences the configuration of the surface, the core tension and the working conclusion with the pieces of dough 5. In an inventive working system 100 having a pressure control unit 20, it is thus advantageously possible to vary the pressure acting on the working inset 4 by the pressure cylinder 7 or the pressure piston 71 during the working process, so that during the entire working process, ideal pressure force for the respectively processing dough or the respective dough consistency can be exerted on the piece of dough 5, thus assuring optimal working of the pieces of dough 5.

Examples of inventive pressure control units 20 are illustrated in detail in FIGS. 4a, 4b, 5 and 6. Thus, FIG. 4a shows a section view through a working cup 3 of an inventive working system 100, which is seen in the working position. This means that the working cup 3 is arranged close to the abutment 1 and a working gap 6 is configured between the working cup 3 and the abutment 1.

A piece of dough 5 that is intended to be worked is seen in the illustrated embodiment on the abutment 1. The working cup 3 comprises a pressure cylinder 7 and a pressure piston 71, wherein the pressure cylinder 7 is connected by a pressure line 21 to the pressure control unit 20. Such a simply configured pressure control unit 20 can, for example, take the form of a hydraulic pump or pneumatic apparatus that can be switched into the pressure line 21. The working inset 4, in turn, is force-transmittingly connected to the pressure piston 71. As can be seen in FIG. 4a, the pressure chamber 7 is empty, so that pressure is not applied to it, no pressure is contiguous with the pressure piston 71 and thus no force is transmitted by the working inset 4. If this is the case, the position of the working inset 4 or its removal in the direction of the abutment 1 is determined depending on the features of the piece of dough 5.

FIG. 4b shows a section view through a working cup 3 in the working position WP, in which pressure is applied to the pressure chamber 7 by the pressure control unit 20 via the pressure line 21. The pressure control unit 20 in this case is configured to apply a predetermined constant pressure, or at least a pressure corresponding to a predetermined pressure characteristic curve, to the pressure cylinder 7.

As can be seen in FIG. 4b, the pressure piston 71 transmits the pressure contiguous with the pressure cylinder 7 to the working inset 4, so that the latter moves in the direction of the abutment 1 or in the direction of the piece of dough 5 and, corresponding to the pressure adjusted by the pressure control unit 20 in the pressure chamber 7, exerts a defined force on the piece of dough 5.

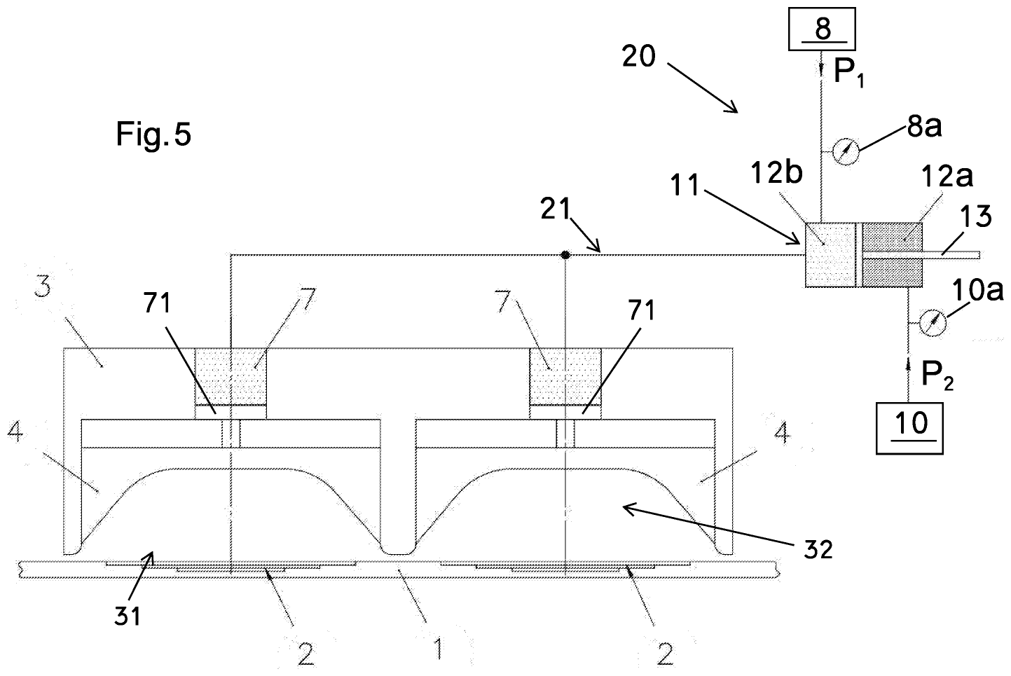

FIG. 5 shows an additional portion of an inventive working system 100, in which the pressure force acting on the working insets 4 can be adjusted by a combined hydraulic-pneumatic pressure control unit 20. The pressure unit 20 in the illustrated embodiment includes a first pressure-generating unit 8 and a second pressure-generating unit 10, which each are pressure-transmittingly connected to two chambers of a pressure transmitting unit 11.

The pressure transmitting unit 11, in turn, is pressure-transmittingly connected to the pressure cylinder 7 of each working cup 3 via a pressure line 21. In the pressure transmitting unit 11, the illustrated embodiment shows a piston storage unit that comprises a hydraulic chamber 12a and a pneumatic chamber 12b. The hydraulic chamber 12a in the embodiment is filled with hydraulic liquid, while the pneumatic chamber 12b is filled with gas or air. The piston storage device also includes a piston 13, which can move inside the piston storage unit and separates the hydraulic chamber 12a from the pneumatic chamber 12b.

The first pressure-generating unit 8 takes the form, in the illustrated embodiment, of a compressor which is pressure-transmittingly connected to the pneumatic chamber 12b. The second pressure-generating unit 10 in the illustrated embodiment is configured as a hydraulic pump, which is pressure-transmittingly connected by lines to the hydraulic chamber 12a.

The pneumatic chamber 12b of the piston storage unit is pre-loaded with adjustable, predetermined gas pressure by the first pressure-generating unit 8 or by the compressor. If rising pressure is now applied to the hydraulic chamber 11a of the piston storage unit, the piston 13 moves in such a way that the volume of the pneumatic chamber 12b is reduced and the gas therein is compressed. Thereby the same pressure prevails in the pneumatic chamber 12b and the hydraulic chamber 12a, so that gas pressure and liquid pressure are in equilibrium and hydraulic liquid is received in the hydraulic chamber 12a. If, however, the pressure acting on the hydraulic chamber 12a should sink, then the thickened gas expands in the pneumatic chamber 12b and reduces the volume of the hydraulic chamber 12a, so that hydraulic liquid is forced out of the latter.

If the same pressures are made available by the first pressure-generating unit 8 and the second pressure-generating unit 10, for example, then a volume equality prevails between the hydraulic chamber 12a and the pneumatic chamber 12b, and the resulting pressure characteristic curve has an angle of 45°. The angles of the pressure characteristic curve here may be freely selected depending on the selected pressure and volume proportions.

To control the pressures applied by the first pressure-generating unit 8 and the second pressure-generating unit 10 in the pneumatic chamber 12b or the hydraulic chamber 12a, two pressure measurement devices 8a or 10a are provided in pressure lines in the illustrated embodiment, which in each case connect the pressure-generating units 8 or 10 with the piston storage unit.

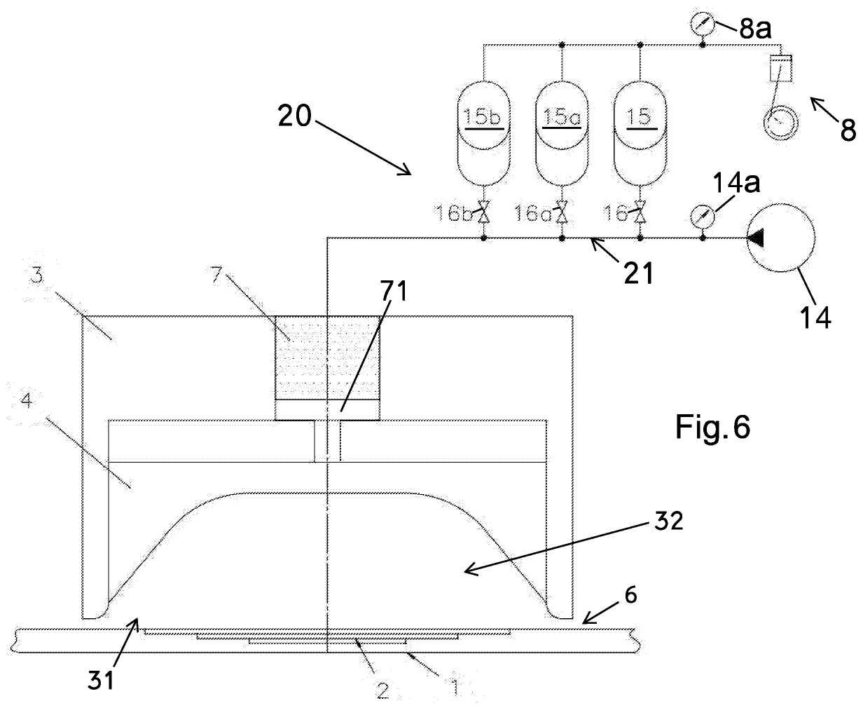

FIG. 6 shows an additional embodiment of an inventive pressure control apparatus 20. The pressure control apparatus 20 here includes a hydraulic pump 14, which is connected by a pressure line 21 to the pressure cylinder 7 of a working cup 3. In the event that several working cups 3 are available, outlets for each of these working cups 3 are present in the pressure line 21.

The pressure control apparatus 20 also includes three pressure storage units 15, 15a, 15b, which take the form in the illustrated embodiment of air/gas-volume storage units. The pressure storage units 15, 15a, 15b are each connected by valves 16, 16a, 16b with the pressure line 21 and thus the respective pressure storage unit 15, 15a, 15b can be switched into the pressure line 21 by opening or closing the valves 16, 16a, 16b of the respective pressure storage unit 15, 15a, 15b. The valves 16, 16a, 16b in the illustrated embodiment are simple shut-off valves.

Pressure of the pressure medium acting on the pressure cylinder 7 is adjusted by the pump 14. The same pressure is contiguous in the pressure storage units 15, 15a, 15b. The pressure storage units 15, 15a, 15b here are configured as bubble storage units, in which an area filled with gas is separated by a bubble, for instance an elastomer bubble, from an area filled with liquid. The hydraulic liquid is pressed under pressure into the liquid-filled area of the pressure storage units 15, 15a, 15b, and thus the gas in the respective other area, separated by the bubble, is compressed.

If the ratio of the volumes in the pressure storage units 15, 15a, 15b changes by opening or closing of the valves 16, 16a, 16b, the rise of the pressure characteristic curve of the pressure working on the pressure cylinder 7 also changes. For example, if the gas in the pressure storage unit 15, 15a, 15b expands upon opening of the respective valve 16, 16a, 16b, a corresponding increase occurs of the rise of the pressure characteristic curve, which acts on the pressure cylinder 7 or the pressure piston 71 of the working cup 3, so that in this way the pressure working on the working inset 4 by opening or closing of the valves 16, 16a, 16b is adjustable.

A flat rise of the pressure characteristic curve can occur if, for example, the pump 14 generates pressure, which is applied via the pressure line 21 in the pressure cylinder 7 and in addition to this contiguous pressure one of the valves 16, 16a, 16b is opened. The rise of this pressure characteristic curve can be increased if in addition another or both remaining valves 16, 16a, 16b are opened. Therefore, the greatest increase in the resulting pressure characteristic curve can be achieved if all three valves 16, 16a, 16b are opened.

Depending on the configuration of the pressure storage units 15, 15a, 15b and on the pressure generated by the pump 14 or the compressor 8, a flatter rise of the resulting pressure characteristic curve can be achieved by switching on the pressure storage units 15, 15a, 15b, so that the slightest rise of the resulting pressure characteristic curve is achieved if all three valves 16, 16a, 16b are opened. Depending on the configuration of the pressure storage units 15, 15a, 15b, by switching on various pressure storage units 15, 15a, 15b, also an increasing or decreasing rise of the resulting pressure characteristic curve can also be achieved.

A pressure control unit 20 configured in this way is particularly advantageous at high capacities that are to be achieved by the working system, because the pressure characteristic curve can be changed quickly owing to the rapid reaction time of the valves 16, 16a, 16b and no losses, or only minor losses, are caused by a change in the pressure characteristic curve, because no further pumping of the pressure medium is required. It is thereby possible, even at high system capacities, to optimally control the properties of the pieces of dough 5 in the working process.

In the illustrated embodiment, the end of the pressure storage units 15, 15a, 15b filled with gas is pre-loaded by a compressor 8. The compressor 8 here is connected by a pressure line to each of the pressure storage units 15, 15a, 15b and a pressure measurement device 8a is tied into the pressure line to check the pressure applied by the compressor 8. A pressure measurement device 14a is likewise tied into the pressure line 21, which connects the pump 14 to the pressure cylinder 7, in order to check the pressure contiguous in the pressure line 21.

Alternatively, an inventive pressure control unit 20 can also include other pressure storage units such as membrane or metal bellows storage devices. Instead of shut-off valves, any other types of valve, for instance pressure or directional valves, can be foreseen.

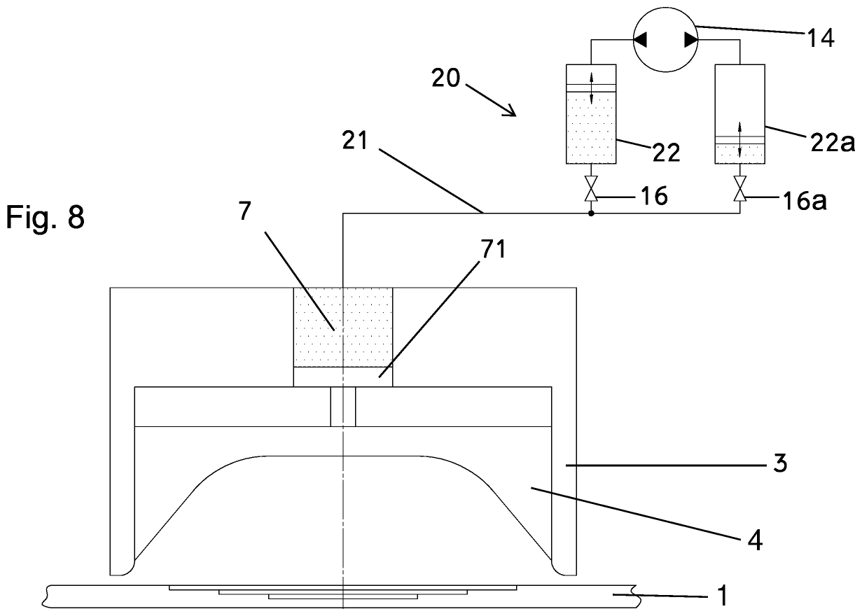

FIG. 8 shows an additional example of an inventive pressure control unit 20, in which two buffer storage units 22, 22a with variable volume, by means of valves 16, 16a, are pressure-transmittingly connected via a pressure line 21 to the pressure cylinder 7 of each working cup 3 of the working system 100. The buffer storage units 22, 22a here are pressure-transmittingly connected to a pump 14, for example a hydraulic pump. The volume or pressure in the buffer storage units 22, 22a can be adjusted by means of the pump 14, so that every buffer storage unit 22, 22a has its own pressure characteristic curve. By opening or closing the valves 16, 16a, the buffer storage units 22, 22a can be switched into the pressure line 21. By combining the pressure characteristic curves of the two buffer storage units 22, 22a or by changing the pressure or volume in the respective buffer storage unit 22, 22a, a number of different resulting pressure characteristic curves can be obtained and the pressure acting on the pressure piston 71 or the force exerted on a piece of dough 5 by the working inset 4 can be optimally adjusted, for example to the respective variety of dough that is to be treated.

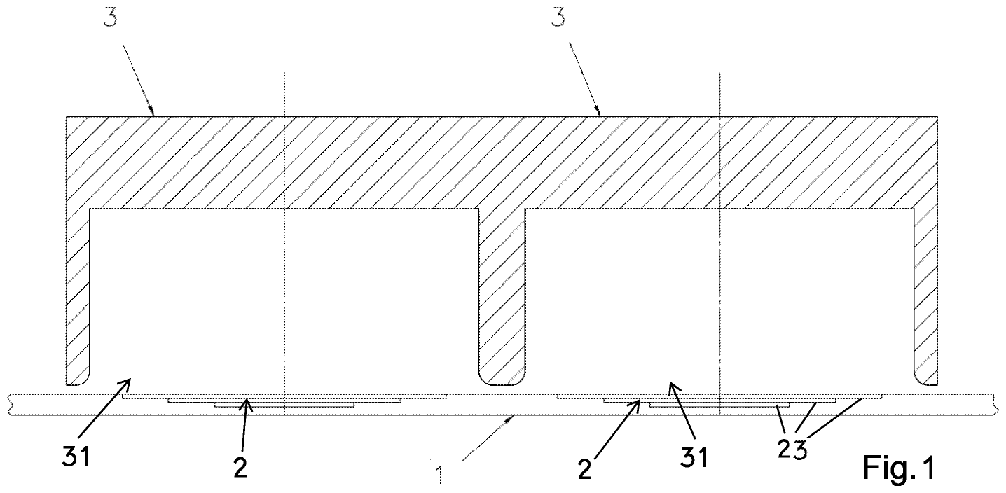

FIG. 1 shows a detail view of two working cups 3 of an inventive working system 100. The working cups 3 here are arranged opposite the abutment 1 and comprise an opening 31. The abutment 1 in the illustrated embodiment includes two working bases 2 for securing the pieces of dough 5 on the abutment 1, so that the pieces of dough 5 cannot slip, for example during the working process, and thus optimal processing of the pieces of dough 5 is ensured. The working bases 2 in the illustrated embodiment are each made up of three concentrically running, recessed grooves 23, as can also be seen in FIG. 2e and FIG. 2f.

FIG. 2a shows schematically a working cup 3, which is shown in working position during the processing, or concretely during rounding, of a piece of dough. The piece of dough 5 here is affixed on the abutment 1 by the working base 2, and a working gap 6, configured between the working cup 3 and the abutment 1, serves to prevent damage to the piece of dough 5 or to its surface during the working process. The working inset 4 is in contact with the surface of the piece of dough 5, because pressure is applied to the pressure cylinder 7 and the pressure piston 71.

FIG. 2b shows a flow chart 30 of the course of a working process. The working cup 3 with working inset 4 is mounted on the piece of dough 5, wherein the working gap 6 is left vacant between the abutment 1 and the working cup 3. The width of the working gap 6 depends on the firmness or the portion of liquid material in the piece of dough 5. The impetus 30 to the working cup 3 starts at point zero or at a predetermined impetus, which is less than the maximum adjusted impetus.

The surface of the piece of dough 5 is tensed by the oscillating motion, which the drive unit 18 in each case causes the working cup 3 to perform, and by an increase in the working impetus 30, while the working bases 2 affix the piece of dough to the abutment 1. This increase in the impetus 30a of the working impetus 30 at the start of the work process is illustrated in FIG. 2c.

The tension on the surface of the pieces of dough 5 increases during working, so that the piece of dough 5 is thereby given a round shape and a working halt occurs. To keep the working halt brief, after configuration of the round shape of the piece of dough 5 an impetus reduction 30b of the working impetus 30, shown in FIG. 2d, is performed.

An inventive working system 100 can be integrated advantageously into dough processing facilities, for example for dough strips. In this context, dough processing facilities are understood to mean those facilities in which dough strips are portioned into pieces of dough 5 and these pieces of dough 5 are each processed further.

For integration into such a dough processing facility, the abutment 1 can comprise a reception side for receiving portioned, non-worked pieces of dough from a first section of the dough processing facility and a delivery side for delivering worked pieces of dough 5 to another section of the dough processing facility. For this purpose the abutment 1 can be configured as an endless conveyor belt, running over deflection rolls, which is arranged in the working system 100.

At one end of the abutment 1 or conveyor belt, the portioned, non-worked pieces of dough are delivered for working at the working system 100, while on the other end of the conveyor belt or abutment 1 they are completed by the working system 100 and turned over at another area of the dough processing facility for further processing steps.

1. A working system for working pieces of dough, including:
at least one working cup, which includes in each case an opening, a receiving space for receiving pieces of dough and a working inset,
wherein the working inset delimits the receiving space on its side remote from the opening,
an abutment, arranged opposite the opening of the working cup,
a height adjustment device, which is designed to reversibly move the at least one working cup from a starting position remote from the abutment to a working position near the abutment, and
a drive unit, which is designed to set the at least one working cup into oscillating motion,
wherein
each of the at least one working cups has a pressure cylinder having a pressure piston that can move in the pressure cylinder, and
a pressure control unit is provided;
wherein in each case the pressure control unit is pressure-transmittingly connected to the pressure cylinder;
wherein the pressure control unit is designed to apply a variable pressure and/or volume to the pressure cylinder; and
the pressure piston is pressure-transmittingly connected to the working insert in such a way that the force on the working insert can be changed when the pressure in the pressure cylinder and/or the pressure characteristic curve of the pressure control unit changes.

2. The working system according to claim 1, wherein the pressure control unit is configured to apply to the pressure cylinder a predetermined, constant pressure or a pressure corresponding at least to a predetermined, particularly variable pressure characteristic curve, so that in each case the force acting on the working inset is adjustable.

3. The working system according to claim 1, wherein the pressure control unit includes a first pressure-generating unit and a second pressure-generating unit,
wherein the first pressure-generating unit and the second pressure-generating unit are each pressure-transmittingly connected to a pressure transmission unit and are configured in such a way that a pressure corresponding at least to a predetermined, particularly variable pressure characteristic curve can be adjusted in the pressure transmission unit and
wherein the pressure transmission unit is pressure-transmittingly connected to the pressure cylinder.

4. The working system according to claim 3, wherein the pressure transmission unit is configured as a piston storage unit,
wherein the piston storage unit comprises a hydraulic chamber, a pneumatic chamber, and a piston arranged between the hydraulic chamber and the pneumatic chamber,
wherein the first pressure-generating unit is pressure-transmittingly connected to the pneumatic chamber,
wherein the second pressure-generating unit is pressure-transmittingly connected to the hydraulic chamber,
wherein, by applying pressure to the hydraulic chamber, pressure corresponding at least to a predetermined, variable pressure characteristic curve can be adjusted in the piston storage unit, and
wherein the piston storage unit is configured to change the pressure and/or volume in the pressure cylinder.

5. The working system according to claim 1, wherein the pressure control unit includes at least a pump and a number of pressure storage units,
wherein the at least one pump is connected by a pressure line to the pressure cylinder,
wherein the pressure storage units can be switched into the pressure line by valves and in each case have a predetermined, changeable pressure characteristic curve, and
wherein the pressure storage units can each be switched into the pressure line by valves and each include a predetermined, changeable pressure characteristic curve, and
wherein the pressure control unit is configured, by opening and/or closing the valves, to apply to the pressure cylinder of the at least one working cup a pressure corresponding to a particularly variable pressure characteristic curve resulting from the pressure characteristic curves of the pressure storage units.

6. The working system according to claim 1, wherein the working inset is designed to transmit as a force acting orthogonally to the abutment the pressure transmitted by the pressure piston to the working inset.

7. The working system according to claim 1, wherein the abutment comprises at least one working base, configured in the form of one or more recesses, to affix the pieces of dough on the abutment, wherein the working base in each case consists of a number of concentric recessed grooves.

8. The working system according to claim 1, wherein in working position, in each case, a working gap is configured between the working cup and the abutment.

9. The working system according to claim 1, wherein the working inset in each case includes a smooth or structured surface and/or
the receiving space has an arched or semicircular cross-section and/or a round or oval projection surface.

10. The working system according to claim 1, wherein the pressure characteristic curve can be adjusted by the pressure control unit corresponding to the dough rheology and/or the starting shape of the pieces of dough.

11. A dough-processing installation for processing dough strips, including a working system, wherein the working system is configured according to claim 1,
wherein the abutment comprises a reception side for receiving pre-portioned, non-worked pieces of dough, and a delivery side for delivering worked pieces of dough and
wherein the dough-processing installation includes at least one transport apparatus, which is configured to deliver particularly pre-portioned, non-worked pieces of dough to the delivery side of the abutment and/or
to receive worked pieces of dough at the delivery side of the abutment.
